(19) United States
(12) Patent Application Publication
(10) Pub. No.: US 2023/0228337 A1
(43) Pub. Date: Jul. 20, 2023

(54) Steam Regulation Valve

(71) Applicant: Instant Brands Holdings Inc., Downers Grove, IL (US)

(72) Inventors: Megan DONNELLY, Darien, IL (US); Scott BIBA, Waunakee, WI (US); Andrew JONCICH, Madison, WI (US)

(73) Assignee: Instant Brands Holdings Inc., Downers Grove, IL (US)

(21) Appl. No.: 18/095,631

(22) Filed: Jan. 11, 2023

Related U.S. Application Data
(60) Provisional application No. 63/301,178, filed on Jan. 20, 2022.

(51) Int. Cl. F16K 17/04; A47J 27/08; A47J 27/09; A23L 5/10

(52) U.S. Cl. CPC F16K 17/046; A47J 27/0815; A47J 27/09; A23L 5/13; F16K 17/12

(57) ABSTRACT

A steam regulation valve, includes: a first portion, a second portion, and a flow path defined by the first portion and the second portion. The second portion is movable relative to the first portion to decrease a cross-sectional area of the flow path in response to an increase in pressure applied to the second portion.

### CROSS-REFERENCE TO RELATED APPLICATIONS

This application claims priority to U.S. Provisional Application No. 63/301,178, filed Jan. 20, 2022, the entirety of which is hereby incorporated by reference.

### FIELD OF THE INVENTION

The present disclosure relates generally to a valve configured for regulating pressure and/or steam release through the valve, which may be used in cooking devices, such as pressure cookers, or other devices involving pressure and/or steam release regulation.

### BACKGROUND

In situations where pressure and/or steam needs to be released from a cooking device relatively quickly and through fairly small openings, it is desirable to control the velocity of the steam release and thus the sound level thereof. A pressure cooker includes a sealed cooking chamber that traps the steam generated as its contents are heated. As steam builds, pressure increases, driving the boiling point of water past 212° F. After active cooking is complete, the pressure built up inside the cooker needs to be released. Most electric pressure cookers have a safety mechanism that prevents the lid from opening until the pressure has been lowered. There are two ways that can be done with electric pressure cookers: natural release and rapid release. In particular, the rapid release of pressure and/or steam from conventional electric pressure cookers can be intimidating for amateur home cooks and those unfamiliar with pressure cooking, due to turbulence and noise associated with the depressurization of those cooking vessels.

### SUMMARY

The present invention is defined by the following claims, and nothing in this section should be considered to be a limitation on those claims.

In one aspect, an embodiment of a steam regulation valve includes a first portion; a second portion; and a flow path defined by the first portion and the second portion, where the second portion is movable relative to the first portion to decrease a cross-sectional area of the flow path in response to an increase in pressure applied to the second portion.

In another aspect, an embodiment of a pressure cooker includes a cooker body and a lid enclosing a cooking chamber; and a steam regulation valve having a valve body, where the steam regulation valve defines a flow path in fluid communication with the cooking chamber, the flow path selectively in fluid communication with an atmosphere surrounding the pressure cooker, and where the valve body is movable to decrease a cross-sectional area of the flow path in response to an increase in pressure in the cooking chamber, and movable to increase the cross-sectional area of the flow path in response to a decrease in pressure in the cooking chamber.

In another aspect, a method of regulating steam release of a pressure cooker with a steam regulation valve, the pressure cooker including a cooker body enclosing a cooking chamber, the method includes: attaching a lid of the pressure cooker to the cooker body for pressurized cooking; moving a portion of the steam regulation valve to a first position to release steam in the cooking chamber via a flow path through the steam regulation valve, the flow path having a first cross-sectional area in response to a first pressure in the cooking chamber; and moving the portion of the steam regulation valve to a second position to release steam in the cooking chamber via the flow path through the steam regulation valve, the flow path having a second cross-sectional area in response to a second pressure in the cooking chamber, where the first pressure is higher than the second pressure, and where the first cross-sectional area is smaller than the second cross-sectional area.

In another aspect, an embodiment of a steam regulation valve includes a main body; and a telescoping housing movable relative to the main body, where the telescoping housing includes at least one opening through which a flow path passes, and where the telescoping housing is movable relative to the main body to decrease a cross-sectional area of the flow path in response to an increase in pressure applied to the telescoping housing.

In another aspect, an embodiment of a steam regulation valve includes a main body; and a collapsible valve body movable relative to the main body between a first configuration and a second configuration, where the collapsible valve body includes at least one opening through which a flow path passes, where the collapsible valve body is moved to the first configuration in response to a first pressure applied to the collapsible valve body, where the flow path has a first cross-sectional area when the collapsible valve body is in the first configuration, where the collapsible valve body is moved to the second configuration in response to a second pressure applied to the collapsible valve body, where the flow path has a second cross-sectional area when the collapsible valve body is in the second configuration, wherein the first pressure is higher than the second pressure, and where the first cross-sectional area is smaller than the second cross-sectional area.

In another aspect, an embodiment of a steam regulation valve includes a main body including a passage configured to provide a flow path through the valve; and a flap disposed adjacent to the passage, where the flap is movable to decrease a cross-sectional area of the flow path in response to an increase in pressure applied to the flap.

In another aspect, an embodiment of a steam regulation valve includes a main body including a passage configured to provide a flow path through the valve; and at least one arm moveable relative to the passage to decrease a cross-sectional area of the flow path in response to an increase in pressure applied to the at least one arm.

In another aspect, an embodiment of a steam regulation valve includes a main body including a narrowing portion, the narrowing portion having a passage through which a flow path passes; and a valve body moveable relative to the passage to decrease a cross-sectional area of the flow path in response to an increase in pressure applied to the valve body.

In another aspect, an embodiment of a steam regulation valve includes a main body having a first passage and a second passage, forming a flow path between the first passage and the second passage; and a valve body having a conduit, where the valve body is moveable relative to the first and second passages to decrease a cross-sectional area of the flow path in response to an increase in pressure applied to the valve body.

In another aspect, an embodiment of a steam regulation valve includes a sleeve extending between an upper portion of the sleeve and a lower portion of the sleeve, the sleeve having an inner lumen extending between the upper portion of the sleeve and the lower portion of the sleeve; and a telescoping housing extending through the inner lumen and having at least one opening through which a flow path passes, where the telescoping housing is movable relative to the sleeve to decrease a cross-sectional area of the flow path in response to an increase in pressure applied to the telescoping housing.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIGS. 1 and 2 are illustrations of an embodiment of a steam regulation valve including a telescoping housing, showing the telescoping housing at different positions in response to different pressures applied to the telescoping housing.

FIGS. 3 and 4 are illustrations of another embodiment of a steam regulation valve including a collapsible housing, showing the collapsible housing with different configurations in response to different pressures applied to the collapsible housing.

FIGS. 5 and 6 are illustrations of another embodiment of a steam regulation valve including a flap, showing the flap at different positions in response to different pressures applied to the flap.

FIGS. 7, 7A, 8, and 8A are illustrations of another embodiment of a steam regulation valve including a ball, showing the ball at different positions in response to different pressures applied to the ball.

FIGS. 9 and 10 are illustrations of another embodiment of a steam regulation valve including at least one arm, showing the at least one arm at different positions in response to different pressures applied to the at least one arm.

FIGS. 11-13 are illustrations of another embodiment of a steam regulation valve including a valve body having a conduit, showing the conduit at different positions in response to different pressures applied to the valve body.

FIG. 14 is an enlarged exploded view of another embodiment of a steam regulation valve including a sleeve and a telescoping housing extending through an inner lumen of the sleeve.

FIG. 15 is an enlarged cross-sectional view of the steam regulation valve of FIG. 14.

FIG. 16 is an enlarged perspective view of a portion of the steam regulation valve of FIG. 14, showing a spring coupled to the telescoping housing.

FIG. 17 is a cross-sectional view of the portion of the steam regulation valve of FIG. 16.

FIG. 18 is an illustration of a pressure cooker including a steam regulation valve associated with the pressure cooker lid.

FIG. 19 is an illustration of a cross section of a pressure cooker, including the steam regulation valve of FIG. 14 associated with the pressure cooker lid.

FIG. 20 is a perspective view illustrating a pressure cooking appliance in accordance with an example embodiment of the present disclosure.

FIG. 21 is a perspective view showing the pressure cooking appliance of FIG. 20 having a lid and a cooker body shown in separation.

FIG. 22 is a perspective exploded view of the pressure cooking appliance of FIG. 20.

FIG. 23 is a partial perspective exploded view of the lid of the pressure cooking appliance of FIG. 20.

### DETAILED DESCRIPTION OF THE PRESENTLY PREFERRED EMBODIMENTS

It should be understood that the term “plurality,” as used herein, means two or more. The term “coupled” means connected to or engaged with whether directly or indirectly, for example with an intervening member, and does not require the engagement to be fixed or permanent, although it may be fixed or permanent (or integral), and includes both mechanical and electrical connection. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first opening may be the same as a second opening, with each simply being applicable to separate but identical components. Relative terminology and broader terms such as “generally,” “about,” “substantially,” and the like will be understood by a person of ordinary skill in the art as providing clear and definite scope of disclosure and/or claiming. For example, the term “generally planar” will be understood as not requiring entirely flat, but rather including that and functional equivalents.

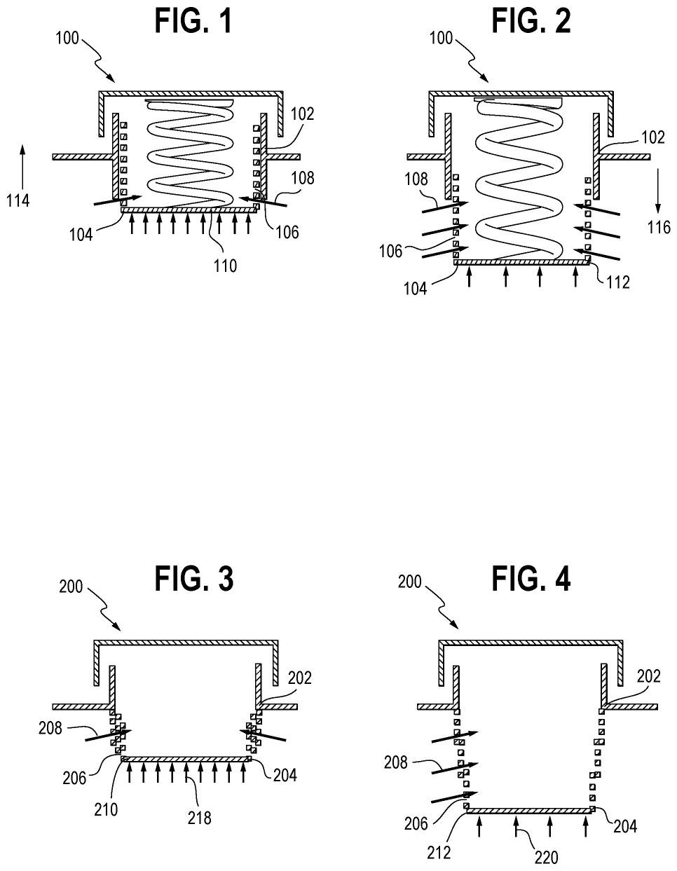

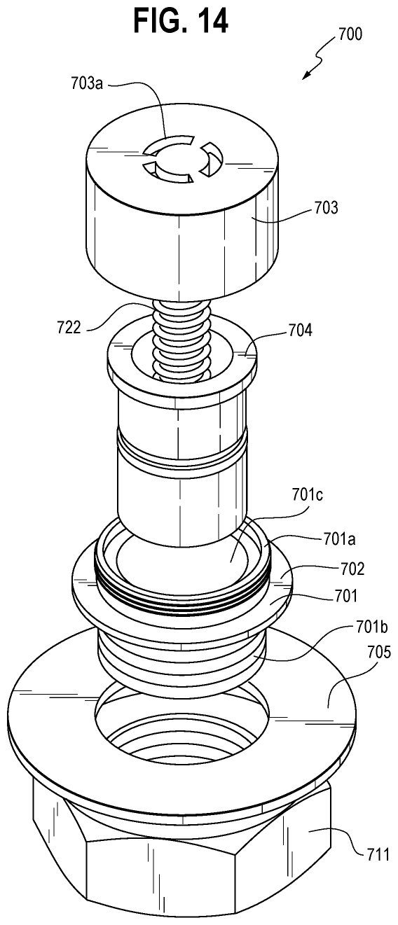

Referring to FIGS. 1-14, various embodiments of a steam regulation valve are shown. As described in greater detail below, each embodiment of the steam regulation valve includes a first portion, a second portion/valve body, and a flow path defined by the first portion and the second portion. In each embodiment, the second portion is movable relative to the first portion to decrease a cross-sectional area of the flow path (either linearly or non-linearly) in response to an increase in pressure applied to the second portion, and the second portion is movable relative to the first portion to increase the cross-sectional area of the flow path (either linearly or non-linearly) in response to a decrease in pressure applied to the second portion.

The ability to decrease a cross-sectional area of the flow path in response to an increase in pressure applied to the second portion of the valve and to increase the cross-sectional area of the flow path in response to a decrease in pressure applied to the second portion of the valve is advantageous for regulating/controlling the velocity of steam and/or pressure release, and thus the sound level thereof. For example, when releasing a high-pressure steam, the velocity of the release is reduced due to the decreased cross-sectional area of the flow path, thereby lowering the sound level of the steam release. As the pressure of the steam goes down, the velocity of the release will further decrease due to the gradually increased cross-sectional area of the flow path, such that the entire process of the steam release will be gentle and will not be slowed down.

Conventional pressure cookers utilize a “binary” valve that is either open or close, and when open, has a fixed cross-sectional area through which steam may pass. When the valve is first opened after cooking, pressure inside the cooking vessel is at its highest, and as such, the size of the opening must be small enough to gradually release the pressure (which will be at high velocity and noisy). However, the size of the valve in conventional pressure cookers will remain the same, even though pressure is decreasing to levels that would permit a larger opening. In that regard, conventional pressure release valves are constrained by the requirement that the valve has a small flow path to accommodate the initial high pressure. By contrast, the valves herein are dynamic, and can be tuned to transition from small openings to larger openings as the pressure changes from high pressures to low pressures. By tuning the size of the opening to correspond to specific pressures, the valves herein can respond to pressure changes and modulate the release over a range of internal vessel pressures.

In each embodiment, the second portion is movable relative to the first portion between a first position and a second position. In each embodiment, the second portion is moved to the first position in response to a first pressure applied to the second portion, where the flow path has a first cross-sectional area when the second portion is in the first position, and the second portion is moved to the second position in response to a second pressure applied to the second portion, where the flow path has a second cross-sectional area when the second portion is in the second position. In each embodiment, when the first pressure is higher than the second pressure, the first cross-sectional area of the flow path is smaller than the second cross-sectional area of the flow path.

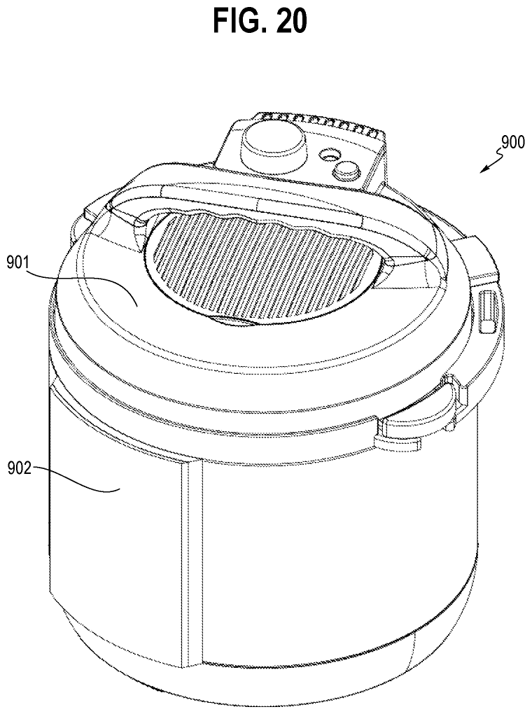

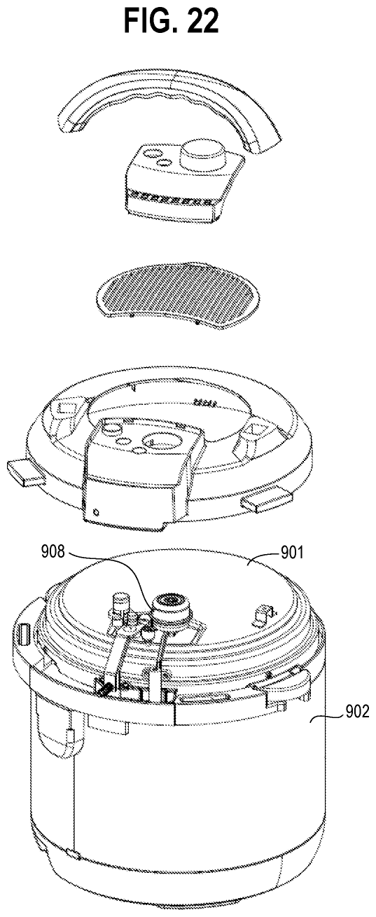

Referring to FIGS. 20-23, a cooking appliance according to an embodiment of the present disclosure is illustrated as a pressure cooking appliance 900, which includes a lid 901 and a cooker body 902 enclosing a cooking chamber 904. The lid 901 is constructed and arranged for covering the cooker body 902. In use, the cooker body 902 and the lid 901 form an enclosed cooking chamber 904 for pressurized cooking.

The lid 901 and the cooker body 902 of the cooking appliance in accordance with example embodiments of the present disclosure are constructed and arranged to have a separable configuration, where the lid 901 can be completely removed or detached from the cooker body 902. The lid 901 can rotate relative to the cooker body 902 between a lid open position and a lid lock position. When the lid is at the lid open location, a user can grasp a lid handle 903 disposed on top of the lid 901 and lift the lid 901. When the lid is at the lid lock location, the lid 901 and the cooker body 902 are mutually latched.

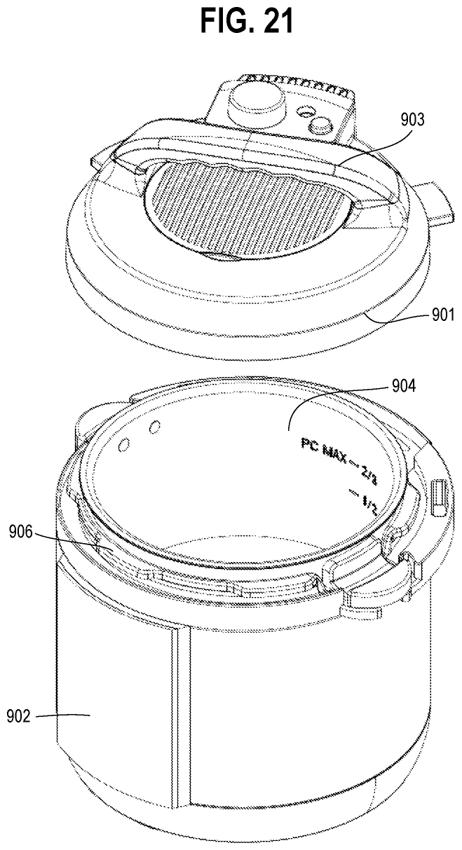

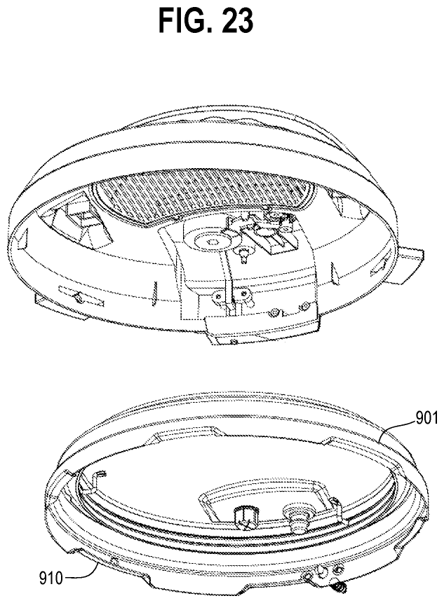

Referring to FIGS. 21 and 23, the lid 901 includes one or more inwardly extending lid teeth 910 formed along a periphery rim of the lid 901. The cooker body 902 includes one or more outwardly extending cooker teeth 906 disposed along a top rim thereof. The lid teeth 910 and the cooker teeth 906 are constructed and arranged to mutually latch to ensure that the lid 901 is locked onto the cooker body 902 during cooking, and that the lid 901 and the cooker body 902 form an enclosed cooking chamber 904 therebetween. The lid 901 may have a steam regulation valve 908 disposed thereon and in communication with the cooking chamber, where the steam regulation valve 908 is operable to be opened upon completion of the cooking process to discharge air from the cooking chamber, so that the temperature and pressure in the cooking chamber can be quickly lowered, thereby allowing the lid to be opened safely in a short time. The steam regulation valve 908 may be any embodiment of the steam regulation valve disclosed in this application.

Referring to FIGS. 1 and 2, an illustration of a first embodiment of the steam regulation valve 100 is shown. In this embodiment, the steam regulation valve 100 includes a first portion, which is a main body 102, and a second portion/valve body, which is a telescoping housing 104 movable relative to the main body 102. The main body 102 and the telescoping housing 104 have matching cross-sectional shapes, including for example, generally circular, generally square, etc. The second portion (telescoping housing 104) is biased towards the second position 112 (e.g., in the second direction 116 (e.g., downwardly, as shown in FIG. 2) relative to the main body 102). The second portion (telescoping housing 104) may be biased by a spring (e.g., as shown in FIGS. 1 and 2), magnet, or gravity, such that a biasing force is applied to the second portion (telescoping housing 104). As the second portion (telescoping housing 104) moves between the first position 110 and the second position 112 (e.g., moves to decrease the cross-sectional area of the flow path in response to an increase in pressure applied to the telescoping housing 104), as described in greater detail below, the biasing force may be constant (e.g., when biased by gravity), change linearly (e.g., when biased by a spring), or change non-linearly (e.g., when biased by a magnet).

The second portion (telescoping housing 104) may include one or more openings 106 (e.g., a plurality of openings, as shown in FIGS. 1 and 2) through which the flow path 108 passes. The main body 102 and the telescoping housing 104 are configured such that the telescoping housing 104 is movable relative to the main body 102 to block/expose different openings of the plurality of openings 106 or different portions of one opening 106.

For example, when the telescoping housing 104 moves in a first direction 114 (e.g., upwardly, as shown in FIG. 1) relative to the main body 102, at least a portion of the at least one opening(s) 106 is blocked by the main body 102, and as the telescoping housing 104 moves further in the first direction 114, more and more portions of the at least one opening(s) 106 may be blocked by the main body 102, and thus the cross-sectional area of the flow path may be decreased. When the telescoping housing 104 moves in a second direction 116 (e.g., downwardly, as shown in FIG. 2) relative to the main body 102, at least a portion of the at least one opening(s) 106 is exposed, and as the telescoping housing 104 moves further in the second direction 116, more and more portions of the at least one opening(s) 106 may be exposed, and thus the cross-sectional area of the flow path may be increased.

For example, when the second portion (telescoping housing 104) is in the first position 110 (e.g., as shown in FIG. 1), a first number of the one or more opening(s) 106 (e.g., two openings, as shown in FIG. 1) may be exposed, and when the second portion (telescoping housing 104) is in the second position 112 (e.g., shown in FIG. 2), a second number of the one or more opening(s) 106 (e.g., ten openings as shown in FIG. 2) may be exposed. The first number may be smaller than the second number (e.g., when the first position 110 is upper than the second position 112, as shown in FIGS. 1 and 2) or equal to (e.g., when the telescoping housing 104 has one opening 106 only) the second number.

In an alternative design of the first embodiment of the steam regulation valve 100, where the valve body (telescoping housing 104) includes one opening 106 only, the opening 106 may extend along a length of the valve body (telescoping housing 104). When the valve body (telescoping housing 104) is in the first position 110 (e.g., as shown in FIG. 1), a first portion of the opening 106 may be exposed, and when the valve body (telescoping housing 104) is in the second position 112 (e.g., as shown in FIG. 2), the first portion of the opening 106 and a second portion of the opening 106 may both be exposed, meaning a larger portion of the opening 106 may be exposed at the second position 112.

Accordingly, in response to an increase in pressure applied to the telescoping housing 104 (e.g., as shown in FIG. 1), the telescoping housing 104 moves in the first direction 114 (e.g., upwardly) relative to the main body 102 to decrease the cross-sectional area of the flow path, and in response to a decrease in pressure applied to the telescoping housing 104, the telescoping housing 104 moves in the second direction 116 (e.g., downwardly) opposite the first direction 114 relative to the main body 102 to increase the cross-sectional area of the flow path.

It will be appreciated that the number, configuration (e.g., shape, size), and arrangements of the openings may be varied, as desired and/or needed, to achieve a particular steam release fashion, without departing from the scope of the present invention. For example, the openings 106 may be uniformly distributed along the telescoping housing 104, or may be non-uniformly distributed. The size of each opening may be uniform, or non-uniform. Accordingly, the cross-sectional area of the flow path may change in either a linear or non-linear fashion as the telescoping housing 104 moves from the first position 110 to the second position 112. It will be appreciated that in an alternative design of the first embodiment of the steam regulation valve 100, the one or more openings 106 may be formed in the main body 102, with the telescoping housing 104 being formed without openings to achieve a similar/same function of pressure/steam release regulation as described above.

Referring to FIGS. 3 and 4, an illustration of a second embodiment of the steam regulation valve 100 is shown. In this embodiment, the steam regulation valve 100 includes a first portion, which is a main body 202, and a second portion/valve body 204, which is a collapsible and movable relative to the main body 102, such that the collapsible valve body 204 transitions between a first configuration 210 (e.g., a collapsed configuration, as shown in FIG. 3) and a second configuration 212 (e.g., an expanded configuration, as shown in FIG. 4). The collapsible valve body 204 may be made of a deformable, elastic material, like rubber, silicone, etc. A biasing force may be applied to the collapsible valve body 204, and as the collapsible valve body 204 moves between the first configuration 210 and the second configuration 212, as described in greater detail below, the biasing force may be constant (e.g., when biased by gravity), change linearly (e.g., when biased by a spring), or change non-linearly (e.g., when biased by a magnet).

The collapsible valve body 204 includes at least one opening(s) 206 (e.g., a plurality of openings 206) through which a flow path 208 passes. A first number of the plurality of openings 206 may be blocked by the collapsed valve body 204 in the first/collapsed configuration 210 (e.g., as shown in FIG. 3), a second number of the plurality of openings 206 may be blocked by the collapsed valve body 204 in the second/expanded configuration 212 (e.g., as shown in FIG. 4), and the first number may be greater than the second number or equal to the second number (e.g., when all the opening(s) are partially blocked/exposed). In other words, when the collapsible valve body 204 is in the first/collapsed configuration 210 (e.g., as shown in FIG. 3), a first number of the plurality of openings 206 may be exposed, when the collapsible valve body 204 is in the second/expanded configuration 212 (e.g., as shown in FIG. 4), a second number of the plurality of openings 206 may be exposed, and the first number may be smaller than or equal to the second number (e.g., when all the opening(s) are partially blocked/exposed).

Accordingly, in response to an increase in pressure applied to the collapsible valve body 204, the collapsible valve body 204 is movable relative to the main body 202 towards the first/collapsed configuration 210 to decrease a cross-sectional area of the flow path 208 linearly/non-linearly. In response to a decrease in pressure applied to the collapsible valve body 204, the collapsible valve body 204 is movable relative to the main body 202 towards the second/expanded configuration 212 to increase a cross-sectional area of the flow path 208 linearly/non-linearly. For example, the collapsible valve body 204 may be moved to the first/collapsed configuration 210 in response to a first pressure 218 applied to the collapsible valve body 204, where the flow path 208 has a first cross-sectional area when the collapsible valve body 204 is in the first/collapsed configuration 210. The collapsible valve body 204 may be moved to the second/collapsed configuration 212 in response to a second pressure 220 applied to the collapsible valve body 204, where the flow path 208 has a second cross-sectional area when the collapsible valve body 204 is in the second/collapsed configuration 212. As shown in FIGS. 3 and 4, the first pressure 218 is higher than the second pressure 220, and the first cross-sectional area of the flow path 208 is smaller than the second cross-sectional area of the flow path 208.

It will be appreciated that the number, configuration (e.g., shape, size), and arrangements of the at least one opening(s) 206 may be varied, as desired and/or needed, to achieve a particular steam release fashion, without departing from the scope of the present invention. For example, the openings 206 may be uniformly distributed along the collapsible valve body 204, or may be non-uniformly distributed. The size of each opening may be uniform, or non-uniform. Accordingly, the cross-sectional area of the flow path may change in either a linear or non-linear fashion as the collapsible valve body 204 moves between the first/collapsed configuration 210 and the second/expanded configuration 212.

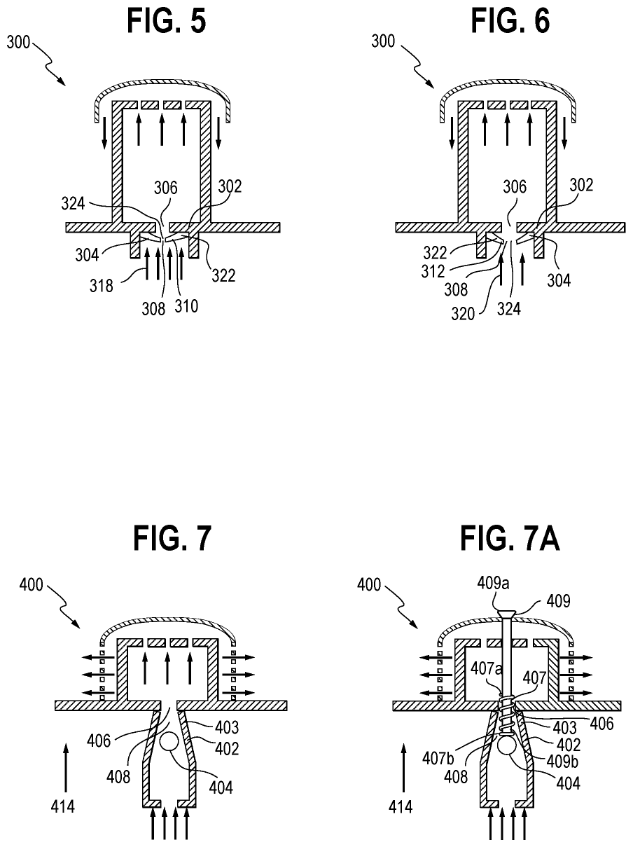

In some embodiments, as shown in FIGS. 5-11, the first portion of the steam regulation valve may define a passage through which the flow path passes. Referring to FIGS. 5 and 6, an illustration of a third embodiment of the steam regulation valve 300 is shown. In this embodiment, the steam regulation valve 300 includes a first portion, which is a main body 302 including a passage 306 configured to provide a flow path 308 through the valve, and a second portion/valve body, which includes a flap 304 disposed along/adjacent to the passage 306.

The flap 304 may have an annular configuration, including a generally planar portion 322 forming an aperture 324. The flap 304 may be made of a deformable elastic material that deforms in response to increased pressure, and returns to its original shape in response to a decrease in pressure. For example, the generally planar portion 322 may be configured to decrease a cross-sectional area of the aperture 324 in response to an increase in pressure applied to the flap 304, and to increase the cross-sectional area of the aperture 324 in response to a decrease in pressure applied to the flap 304. Accordingly, the flap 304 is configured to be movable to decrease the cross-sectional area of the flow path 308 linearly/non-linearly in response to an increase in pressure applied to the flap 304 (e.g., as more of the flow path 308 is blocked by the generally planar portion 322 of the flap 304), and to increase the cross-sectional area of the flow path 308 in response to a decrease in pressure applied to the flap 304 (e.g., as more of the flow path 308 is exposed through the aperture 324 of the flap 304).

For example, the generally planar portion 322 may be movable between a first position 310 and a second position 312. The generally planar portion 322 may be moved to the first position 310 in response to a first pressure 318 applied to the planar portion 322, where the flow path 308 has a first cross-sectional area when the generally planar portion 322 is in the first position 310 (e.g., as shown in FIG. 5). The generally planar portion 322 may be moved to the second position 312 in response to a second pressure 320 applied to the planar portion 322, where the flow path 308 has a second cross-sectional area when the generally planar portion 322 is in the second position 312 (e.g., as shown in FIG. 6). When the first pressure 318 is higher than the second pressure 320, as shown in FIGS. 5 and 6, the first cross-sectional area of the flow path is smaller than the second cross-sectional area of the flow path, as the cross-sectional area of the aperture 324 is smaller, when the generally planar portion 322 is at the first position 310, than the cross-sectional area of the aperture 324, when the generally planar portion 322 is at the second position 312.

A biasing force may be applied to the flap 304, and as the flap 304 moves to decrease/increase the cross-sectional area of the flow path 308 in response to an increase/decrease in pressure applied to the flap 304, the biasing force may be constant, change linearly, or change non-linearly. The flap 304 may be made of rubber, and when installed, the flap 304 would be in a non-deformed state, and as pressure is applied, and the flap 304 deforms, the elasticity of the flap 304 would bias the flap 304 toward the non-deformed state, such that as pressure decreases, the flap 304 returns to the non-deformed state. For example, an elastic force may bias the generally planar portion 322 towards the second position 312 when the generally planar portion 322 is in the first position 310.

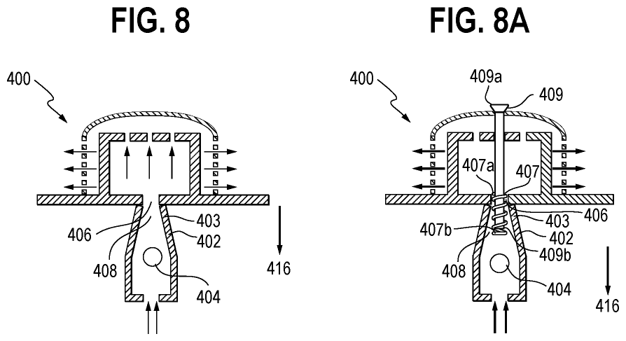

Referring to FIGS. 7, 7A, 8, and 8A, an illustration of a fourth embodiment of the steam regulation valve 400 is shown. In this embodiment, the steam regulation valve 400 includes a first portion, which is a main body 402 including a narrowing portion 403, where the narrowing portion 403 has a passage 406 through which a flow path 408 passes. It will be appreciated that the narrowing portion 403 may have any suitable shapes, including but not limited to, cone, curved walls (e.g., trumpet-shaped). The steam regulation valve 400 also includes a second portion/valve body 404 moveable relative to the passage 406. The valve body 404 may have any suitable shapes, including but not limited to a ball, as shown in FIGS. 7, 7A, 8, and 8A, a cone, and a cube, where the outer surface of the valve body 404 and the narrowing portion 403 define at least a portion of the flow path 408.

The valve body 404 is configured to be moved in a first direction 414 in the narrowing portion 403 (e.g., towards the passage 406, as shown in FIG. 7) to decrease the cross-sectional area of the flow path 408 linearly/non-linearly in response to an increase in pressure applied to the valve body 404. The valve body 404 is also configured to be moved in a second direction 416 opposite the first direction 414 in the narrowing portion 403 (e.g., away from the passage 406, as shown in FIG. 8) to increase the cross-sectional area of the flow path 408 linearly/non-linearly in response to a decrease in pressure applied to the valve body 404. Different shapes of the narrowing portion 403 and/or the valve body 404 may result in different linear or non-linear changes of the cross-sectional area of the flow path 408 when the valve body 404 moves in the narrowing portion 403. For example, when the narrowing portion 403 has a cone shape and the valve body 404 is a ball, as shown in FIGS. 7 and 8, the cross-sectional area of the flow path 408 may change non-linearly as the valve body 404 moves relative to the narrowing portion 403. As another example, when the narrowing portion 403 has a cone shape and the valve body 404 is a cube, the cross-sectional area of the flow path 408 may change linearly as the valve body 404 moves relative to the narrowing portion 403.

The narrowing portion 403 has a trapezoid-shaped cross section with decreasing diameters towards the passage 406. It will be appreciated that the configuration (e.g., shape, size) of the narrowing portion 403 and the valve body 404 may be varied, as desired and/or needed, without departing from the scope of the present invention, as long as the valve body 404 may be moved relative to the passage 406 in the narrowing portion 403 to decrease/increase the cross-sectional area of the flow path 408 in response to an increase/decrease in pressure applied to the valve body 404.

A biasing force may be applied to the valve body 404, and as the valve body 404 moves to decrease/increase the cross-sectional area of the flow path 408 in response to an increase/decrease in pressure applied to the valve body 404, the biasing force may be constant (e.g., applied by gravity), change linearly (e.g., applied by a spring), or change non-linearly (e.g., applied by a magnet). For example, as shown in FIGS. 7A and 8A, the steam regulation valve 400 may include a stop 409 extending between a first end 409a and a second end 409b, where the stop 409 is configured to extend downwardly through the passage 406 to a certain distance to prevent the valve body 404 from moving upwardly after contacting the second end 409b of the stop 409. The stop 409 may be moved upwardly or downwardly (e.g., by rotating the stop 409 with a threaded configuration) relative to the main body 402, such that the valve body 404 may be stopped from moving further upwardly at different locations/heights, thereby providing different cross-sectional areas of a minimum flow path. As shown in FIGS. 7A and 8A, the steam regulation valve 400 may include a spring 407 to provide a biasing force applied to the valve body 404. The spring 407 may extend between a first end 407a and a second end 407b. The first end 407a of the spring 407 may be coupled to a portion of the stop 409. The second end 407b of the spring 407 may be coupled to the valve body 404 or may not be coupled to the valve body 404 (e.g., as shown in FIG. 8A) without departing from the scope of the present invention.

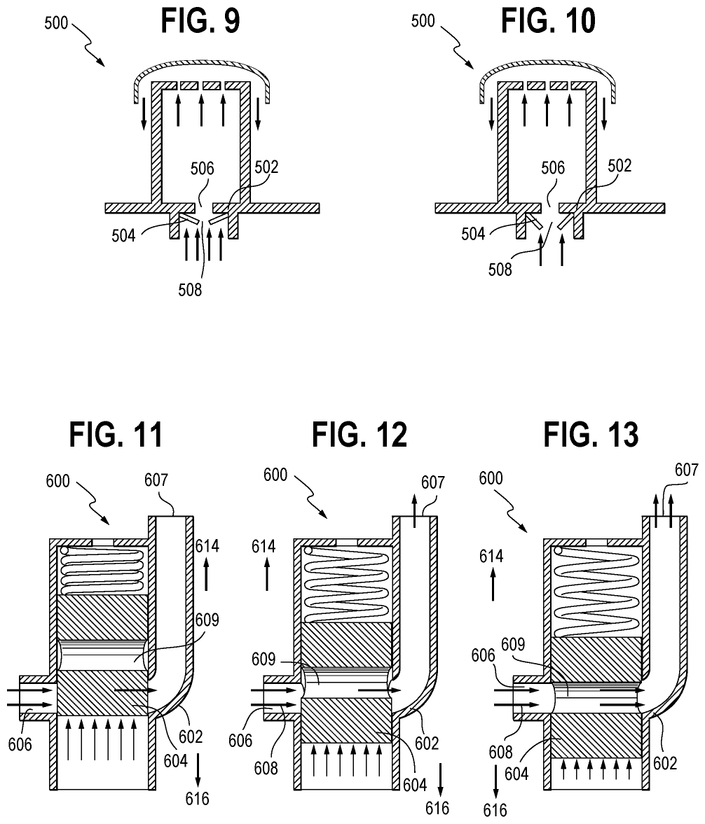

Referring to FIGS. 9 and 10, an illustration of a fifth embodiment of the steam regulation valve 500 is shown. In this embodiment, the steam regulation valve 500 includes a first portion, which is a main body 502 including a passage 506 configured to provide a flow path 508 through the valve 500. The steam regulation valve 500 also includes a second portion/valve body, which comprises at least one arm 504 moveable relative to the passage 506. The at least one arm 504 may be pivotably coupled (e.g., via a hinge) to the main body 502 to selectively block at least a portion of the passage 506 (e.g., as the at least one arm 504 pivots about an axis of rotation), resulting a flow path 508 with different cross-sectional areas. A biasing force may be applied to the at least one arm 504, and as the at least one arm 504 moves to decrease/increase the cross-sectional area of the flow path 508 in response to an increase/decrease in pressure applied to the at least one arm 504, as described in greater detail below, the biasing force may be constant (e.g., applied by gravity), change linearly (e.g., applied by a spring), or change non-linearly (e.g., applied by a magnet).

In response to an increase in pressure applied to the at least one arm 504 (e.g., as shown in FIG. 9), the at least one arm 504 is moveable relative to the passage 506 (e.g., towards the passage 506) to decrease the cross-sectional area of the flow path 508 linearly/non-linearly (e.g., by blocking a larger portion of the passage 506). In response to a decrease in pressure (e.g., as shown in FIG. 10) applied to the at least one arm 504, the at least one arm 504 is moveable relative to the passage 506 (e.g., away from the passage 506) to increase the cross-sectional area of the flow path 508 (e.g., by blocking a smaller portion of the passage 506).

For example, the at least one arm 504 may include two arms. The two arms move towards each other to decrease the cross-sectional area of the flow path 508 in response to an increase in pressure applied to the two arms (e.g., as shown in FIG. 9), and the two arms may move away from each other to increase the cross-sectional area of the flow path 508 in response to a decrease in pressure applied to the two arms (e.g., as shown in FIG. 10). The configuration (e.g., shape, size) and the number of arm(s) may be varied, as desired and/or needed, without departing from the scope of the present invention, as long as the arm(s) are movable relative to the passage 506 to block a larger portion of the passage 506 in response to an increase in pressure applied to the arm(s), and are movable relative to the passage 506 to block a smaller portion of the passage 506 in response to a decrease in pressure applied to the arm(s).

Referring to FIGS. 11-13, an illustration of a sixth embodiment of the steam regulation valve 600 is shown. In this embodiment, the steam regulation valve 600 includes a first portion, which is a main body 602 including a first passage 606 and a second passage 607, forming a flow path 608 between the first passage 606 and the second passage 607. The steam regulation valve 600 also includes a second portion/valve body 604, which includes a conduit 609 movable relative to the first passage 606 and the second passage 607 of the main body 602. As shown, the conduit 609 selectively connects the first passage 606 and the second passage 607 (e.g., selectively in fluid communication with the first passage 606 and the second passage 607) to form the flow path 608 with varying cross-sectional areas.

As shown in FIGS. 11-13, in response to an increase in pressure applied to the valve body 604, the valve body 604 is moved in a first direction 614 (e.g., upwardly) relative to the main body 602 (and relative to the first passage 606 and the second passage 607) to decrease a cross-sectional area of the conduit 609 that is in fluid communication with the first and second passages 606 and 607, thereby decreasing the cross-sectional area of the flow path 608 linearly/non-linearly. For example, the cross-sectional area of the flow path 608 would change linearly if the first and second passages 606 and 607 and the conduit 609 are square, but would change non-linearly if their shapes are circular. In response to a decrease in pressure applied to the valve body 604, the valve body 604 is moved in a second direction 614 (e.g., downwardly) opposite the first direction 614 relative to the main body 602 (and relative to the first and second passages 606 and 607) to increase a cross-sectional area of the conduit 609 that is in fluid communication with the first and second passages 606 and 607, thereby increasing the cross-sectional area of the flow path 608.

A biasing force may be applied to the valve body 604, such that the valve body 604 is biased towards the flow path 608 between the first passage 606 and the second passage 607. For example, the valve body 604 may be biased by a spring, magnet, or gravity. As the valve body 604 moves to decrease/increase the cross-sectional area of the flow path 608 in response to an increase/decrease in pressure applied to the valve body 604, as described above, the biasing force may be constant (e.g., applied by gravity), change linearly (e.g., applied by a spring), or change non-linearly (e.g., applied by a magnet).

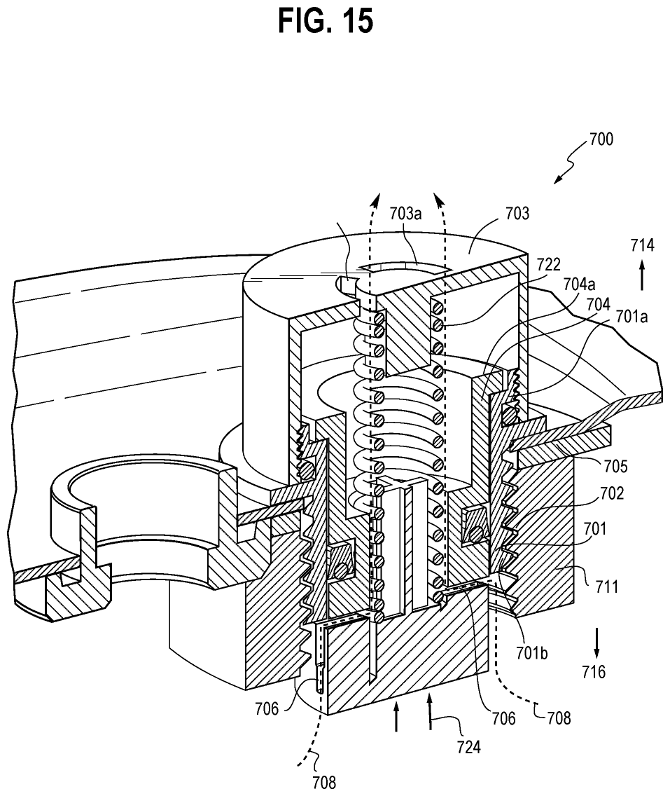

Referring to FIGS. 14-16, a seventh embodiment of the steam regulation valve 700 is shown. In this embodiment, the steam regulation valve 700 includes a first portion 702, which includes a sleeve 701 extending between an upper portion 701a of the sleeve 701 and a lower portion 701b of the sleeve 701. The upper portion 701a and the lower portion 701b of the sleeve 701 each may have a threaded configuration, as shown in FIGS. 14 and 15. The sleeve 701 has an inner lumen 701c extending between the upper portion 701a of the sleeve 701 and the lower portion 701b of the sleeve 701. The first portion 702 also includes a cap 703 coupled to the upper portion 701a of the sleeve 701 (e.g., via corresponding threaded configurations, as shown in FIG. 15). The cap 703 includes at least one opening(s) 703a. The first portion 702 may also include a gasket 705 and a nut 711 configured for securing the sleeve 701 via the lower portion 701b of the sleeve 701 (e.g., via the threaded configuration of the lower portion 701b).

The steam regulation valve 700 also includes a second portion/valve body, which includes a telescoping housing 704 extending through the inner lumen 701c of the sleeve 701 and including at least one opening(s) 706 through which a flow path 708 passes. The inner lumen 701c of the sleeve 701 and the telescoping housing 704 have matching cross-sectional shapes, including for example, generally circular, generally square, etc. As described in greater detail below, the telescoping housing 704 is configured to be movable relative to the first portion (e.g., the sleeve 701) through the inner lumen 701c of the sleeve 701 to decrease the cross-sectional area of the flow path 708 linearly/non-linearly in response to an increase in pressure applied to the telescoping housing 704, and the telescoping housing 704 is configured to be movable relative to the first portion (e.g., the sleeve 701) to increase the cross-sectional area of the flow path 708 in response to a decrease in pressure applied to the telescoping housing 704.

It will be appreciated that the number, configuration (e.g., shape, size), and arrangements of the at least one opening(s) 706 may be varied, as desired and/or needed, to achieve a particular steam release fashion, without departing from the scope of the present invention. For example, the openings 706 may be uniformly distributed along the telescoping housing 704, or may be non-uniformly distributed. The size of each opening may be uniform, or non-uniform. Accordingly, the cross-sectional area of the flow path may change in either a linear or non-linear fashion as the telescoping housing 704 moves relative to the first portion (e.g., the sleeve 701) through the inner lumen 701c of the sleeve 701. It will be appreciated that in an alternative design of this embodiment of the steam regulation valve 700, the at least one opening(s) 706 may be formed in the first portion (e.g., the sleeve 701), with the telescoping housing 704 being formed without openings to achieve a similar/same function of pressure/steam release regulation as described above.

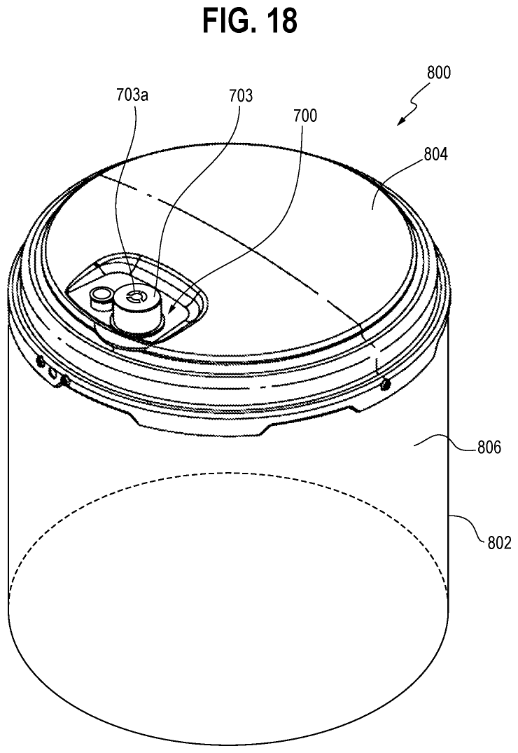

A biasing force may be applied to the telescoping housing 704, and as the telescoping housing 704 moves relative to the sleeve 701 to decrease/increase the cross-sectional area of the flow path 708 in response to an increase/decrease in pressure applied to the telescoping housing 704, as described in greater detail below, the biasing force may be constant (e.g., applied by gravity), change linearly (e.g., applied by a spring), or change non-linearly (e.g., applied by a magnet). For example, as shown, the telescoping housing 704 may be coupled to the cap 703 via a spring 722 such that the telescoping housing 704 is biased downwardly and movable up and down relative to the sleeve 701 along the inner lumen 701c of the sleeve 701. The spring 722 may be adjustable to provide varying biasing forces. For example, the cap 703 may be threaded onto another portion of the valve 700 and/or a lid (e.g., lid 804 as shown in FIG. 18), such that rotation of the cap 703 moves the cap 703 up/down, thereby changing the level of bias applied to the telescoping housing 704 coupled to the cap 703 via the spring 722. In another example, the spring 722 may be configured such that a user may adjust the spring position to “fine-tune” the biasing force of the spring 722 and experiment with different starting and ending spring locations, such that a user can set their own level of comfort with steam release regulation. The sleeve 701, the cap 703, the telescoping housing 704, and the spring 722 may be configured such that they can be disassembled for cleaning separately.

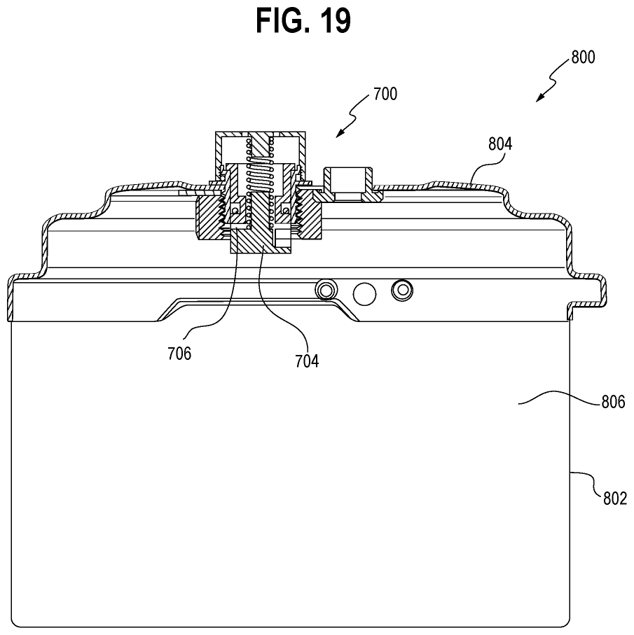

As shown in FIG. 15, the telescoping housing 704 includes an upper flange 704a, which rests upon the upper portion 701a of the sleeve 701, such that the telescoping housing 704 reaches its lowest position, where the at least one opening(s) 706 of the telescoping housing 704 is exposed. In response to an increase in pressure 724 applied to the telescoping housing 704, the telescoping housing 704 moves in a first direction 714 (e.g., upwardly; away from the cooking chamber 806 of a pressure cooker 800, when the valve is associated with the lid 804 of the pressure cooker 800, as described below with reference to FIGS. 18 and 19) relative to the sleeve 701 (along the inner lumen 701c of the sleeve 701), such that the at least one opening(s) 706 is at least partially blocked by the lower portion 701b of the sleeve 701, thereby decreasing the cross-sectional area of the flow path 708. In response to a decrease in pressure applied to the telescoping housing 704, the telescoping housing 704 moves in a second direction 716 (e.g., downwardly) opposite the first direction 714 relative to the sleeve 701 (along the inner lumen 701c of the sleeve 701), such that more and more portions of the at least one opening(s) 706 are exposed, thereby increasing the cross-sectional area of the flow path 708.

The telescoping housing 704 may include a plurality of openings with the same or different configurations (e.g., two openings 706 with different configurations, as shown in FIG. 17). It will be appreciated that the number and configuration of the at least one opening(s) 706 may be varied, as desired and/or needed, without departing from the scope of the present invention, such that the cross-sectional area of the flow path 708 may be increased/decreased in a desired way as the telescoping housing 704 moves relative to the sleeve 701.

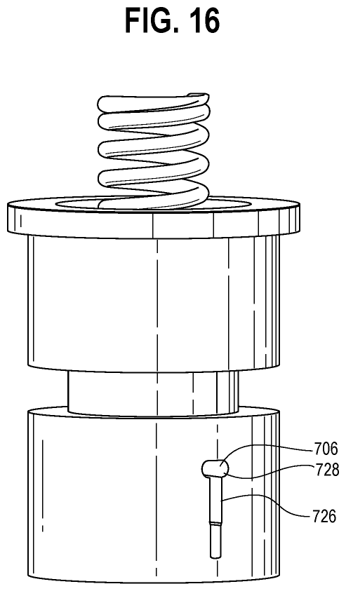

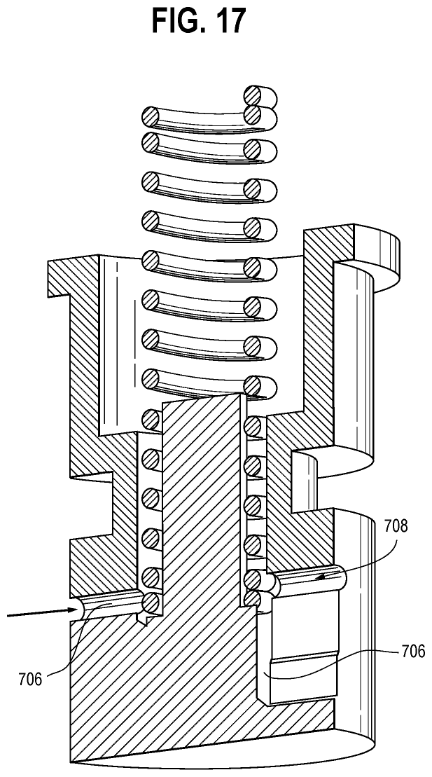

As one non-limiting example, as shown in FIG. 16, the telescoping housing 704 includes at least one opening(s) 706 extending along a length of the telescoping housing 704. The at least one opening(s) 706 may have a first section 726 and a second section 728 disposed along the length of the telescoping housing 704. As shown, the second section 728 is wider than the first section 726 of the at least one opening(s) 706. The first section 726 may be configured (e.g., with a constant width along the length of the first section 726) such that when the telescoping housing 704 moves relative to the sleeve 701 in the second direction 716 (e.g., moves toward the cooking chamber 806 of a pressure cooker 800, when the valve is associated with the lid 804 of the pressure cooker 800, as described below with reference to FIGS. 18 and 19) to expose the first section 726 of the at least one opening(s) 706, the cross-sectional area of the flow path 708 increases linearly. As the telescoping housing 704 continues to move relative to the sleeve 701 in the second direction 716 to expose the second section 728 of the at least one opening(s) 706, the cross-sectional area of the flow path 708 may increase non-linearly.

Each embodiment of the team regulation valve discussed above may be used in a cooking device, such as a pressure cooker. Referring to FIGS. 18 and 19, where illustrations of a pressure cooker 800 including the seventh embodiment of the steam regulation valve 700 are shown as a representative, the pressure cooker 800 may include a cooker body 802 and a lid 804 enclosing a cooking chamber 806. Each embodiment of the steam regulation valve may be associated with the lid and/or the cooker body (e.g., the steam regulation valve 700 is associated with the lid 804, as shown in FIGS. 18 and 19).

Each embodiment of the team regulation valve may define a flow path in fluid communication with the cooking chamber, and the flow path may be selectively in fluid communication with an atmosphere surrounding the pressure cooker. For example, each embodiment of the steam regulation valve may include a first passage (e.g., the at least one opening(s) 706 of the telescoping housing 704, as shown in FIG. 19) in fluid communication with the cooking chamber and a second passage (e.g., the at least one opening(s) 703a of the cap 703) selectively in fluid communication with the atmosphere. Each embodiment of the steam regulation valve includes a valve body (e.g., the telescoping housing 704 as shown in FIG. 19). In operation, the second passage may be closed/sealed (e.g., to provide pressure cooking functions), and when steam release is needed, a portion of the valve may be manipulated (e.g., by rotating the cap 703), such that the second passage is in fluid communication with the atmosphere, allowing steam release to be actuated.

The valve body may be movable relative to the cooking chamber (e.g., moves away from the cooking chamber) to decrease the cross-sectional area of the flow path linearly or non-linearly in response to an increase in pressure in the cooking chamber, and movable relative to the cooking chamber (e.g., moves toward the cooking chamber) to increase the cross-sectional area of the flow path linearly or non-linearly in response to a decrease in pressure in the cooking chamber. As discussed above, this feature is advantageous for regulating/controlling the velocity of a steam release and thus the sound level thereof. For example, when releasing a high-pressure steam, the velocity of the release is reduced due to the decreased cross-sectional area of the flow path, thereby lowering the sound level of the steam release. As the pressure of the steam goes down, the velocity of the release will further decrease due to the gradually increased cross-sectional area of the flow path, such that the entire process of the steam release will be gentle and will not be slowed down.

Referring to FIGS. 18 and 19, as to the seventh embodiment of the steam regulation valve 700, below is an example of the corresponding relationship among the distance of displacement of the spring (L), the cross-sectional area of the flow path (A1), the collective cross-sectional area of the opening(s) 703a (A2), the pressure in the cooking chamber (Pressure), and the measured sound level of the steam release via the flow path (dB). It will be appreciated that these numbers may be varied, as desired and/or needed, by varying the configuration (e.g., shape, size, material) of the first and second portions of the valve (e.g., the configuration and number of openings), without departing from the scope of the present invention.

| L | A1 | A2 | Pressure | Sound |
|---|---|---|---|---|
| (in) | (in\hat{ }2) | (in\hat{ }2) | (psi) | Level (dB) |
| 0 | 0 | 0.06 | 26.0 | — |
| 0.05 | 0.0017 | 0.06 | 23.9 | 65 |
| 0.1 | 0.0034 | 0.06 | 21.8 | 60 |
| 0.15 | 0.0054 | 0.06 | 19.7 | 57 |
| 0.2 | 0.0074 | 0.06 | 17.6 | 54 |
| 0.25 | 0.0094 | 0.05 | 15.5 | 51 |
| 0.27 | 0.0143 | 0.06 | 14.7 | 48 |

In each embodiment of the steam regulation valves described above, cross-sectional areas of the flow path and the amount of bias applied at certain internal pressures may be adjusted and/or configured so that the valves depressurize the cooking vessel in the same as or less time than a conventional pressure cooker. For example, the valves may be tuned to maintain a small cross-sectional area of the flow path at high pressures, but then rapidly (exponentially) increase the cross-sectional area as pressure drops, so that depressurization occurs in a shorter amount of time, while still modulating the release of pressure/steam, and corresponding noise.

In some embodiments, the valve body (e.g., the telescoping housing 704, as shown in FIG. 19) is biased towards the cooking chamber 806 by a spring, magnet, or gravity. The spring and magnet may be adjustable to provide varying biasing forces, for example, by adjusting their locations, spring rate, and/or magnet strength. A stronger spring or magnet may have a larger initial cross-sectional area of the flow path for steam to release and a slower rate of displacement (e.g., a slower rate of changing the size of the cross-sectional area of the flow path in response to a decrease in pressure in the cooking chamber). A weaker spring or magnet may have a smaller initial cross-sectional area of the flow path for steam to release and a quicker rate of displacement (e.g., a quicker rate of changing the size of the cross-sectional area of the flow path in response to a decrease in pressure in the cooking chamber). Changing the location of the spring/magnet may create a smaller or larger initial cross-sectional area of the flow path but may keep the rate of displacement (e.g., the rate of changing the size of the cross-sectional area of the flow path in response to a decrease in pressure in the cooking chamber) the same.

A method of regulating steam release of a pressure cooker with a steam regulation valve discussed above will be provided below, where the pressure cooker includes a cooker body enclosing a cooking chamber. In response to a first pressure in the cooking chamber, the pressure in the cooking chamber moves a portion of the steam regulation valve to a first position to release the steam in the cooking chamber via a flow path through the steam regulation valve, the flow path having a first cross-sectional area. In response to a second pressure in the cooking chamber, the pressure in the cooking chamber moves the portion of the steam regulation valve to a second position to release the steam in the cooking chamber via the flow path through the steam regulation valve, the flow path having a second cross-sectional area. When the first pressure is higher than the second pressure, the first cross-sectional area is smaller than the second cross-sectional area.

As the pressure in the cooking chamber changes from the first pressure to the second pressure, a biasing force moves the portion of the steam regulation valve over time from the first position to the second position, and as the pressure in the cooking chamber changes from the second pressure to the first pressure, the pressure in the cooking chamber moves the portion of the steam regulation valve over time from the second position to the first position. When the first pressure is higher than the second pressure, the second position is closer to the cooking chamber than the first position. In other words, in response to an increase in pressure in the cooking chamber, the pressure in the cooking chamber moves the portion of the steam regulation valve from the second position to the first position, and in response to a decrease in pressure in the cooking chamber, a biasing force moves the portion of the steam regulation valve from the first position to the second position, where the second position is closer to the cooking chamber than the first position.

As the portion of the steam regulation valve moves between the first position and the second position over time, the cross-sectional area of the flow path may be changed linearly, non-linearly, or exponentially. A biasing force may be applied to the portion of the steam regulation valve, and as the portion of the steam regulation valve moves between the first position and the second position, the biasing force may be constant (e.g., applied by gravity), change linearly (e.g., applied by a spring), or change non-linearly (e.g., applied by a magnet).

Various embodiments of a steam regulation valve may be provided as described above.

A1 In an example, a steam regulation valve comprises: a first portion; a second portion; and a flow path defined by the first portion and the second portion, where the second portion is movable relative to the first portion to decrease a cross-sectional area of the flow path in response to an increase in pressure applied to the second portion.

A2 The steam regulation valve of example A1, where the second portion is movable relative to the first portion to increase the cross-sectional area of the flow path in response to a decrease in pressure applied to the second portion.

A3 The steam regulation valve of example A1 or A2, where the second portion is movable relative to the first portion to decrease the cross-sectional area of the flow path linearly in response to an increase in pressure applied to the second portion.

A4 The steam regulation valve of any of examples A1-A3, where the second portion is movable relative to the first portion to decrease the cross-sectional area of the flow path non-linearly in response to an increase in pressure applied to the second portion.

A5 The steam regulation valve of any of examples A1-A4, where the second portion is movable relative to the first portion between a first position and a second position, where the second portion is moved to the first position in response to a first pressure applied to the second portion, the flow path having a first cross-sectional area when the second portion is in the first position, where the second portion is moved to the second position in response to a second pressure applied to the second portion, the flow path having a second cross-sectional area when the second portion is in the second position, where the first pressure is higher than the second pressure, and where the first cross-sectional area of the flow path is smaller than the second cross-sectional area of the flow path.

A6 The steam regulation valve of any of examples A1-A5, where the second portion is biased towards the second position.

A7 The steam regulation valve of any of examples A1-A6, where the second portion is biased by a spring, magnet, or gravity.

A8 The steam regulation valve of any of examples A1-A7, where a biasing force is applied to the second portion, and where as the second portion moves between the first position and the second position, the biasing force is constant.

A9 The steam regulation valve of any of examples A1-A8, where a biasing force is applied to the second portion, and where as the second portion moves between the first position and the second position, the biasing force changes linearly.

A10 The steam regulation valve of any of examples A1-A9, where a biasing force is applied to the second portion, and where as the second portion moves between the first position and the second position, the biasing force changes non-linearly.

A11 The steam regulation valve of any of examples A1-A10, where the second portion includes one or more openings through which the flow path passes, where when the second portion is in the first position, a first number of the one or more openings are exposed, where when the second portion is in the second position, a second number of the one or more openings are exposed, and where the first number is smaller than or equal to the second number.

A12 The steam regulation valve of any of examples A1-A11, where the second portion is collapsible and movable relative to the first portion between a first configuration and a second configuration.

A13 The steam regulation valve of any of examples A1-A12, where the first portion defines a passage through which the flow path passes.

A14 The steam regulation valve of any of examples A1-A13, where the second portion comprises a flap disposed along the passage, and where the flap is configured to decrease the cross-sectional area of the flow path in response to an increase in pressure applied to the flap.

A15 The steam regulation valve of any of examples A1-A14, where the second portion comprises at least one arm moveable relative to the passage to decrease the cross-sectional area of the flow path in response to an increase in pressure applied to the at least one arm.

A16 The steam regulation valve of any of examples A1-A15, where the second portion comprises a ball moveable relative to the passage to decrease the cross-sectional area of the flow path in response to an increase in pressure applied to the ball.

A17 The steam regulation valve of any of examples A1-A16, where the second portion comprises a conduit moveable relative to the passage to decrease the cross-sectional area of the flow path in response to an increase in pressure applied to the second portion.

A18 The steam regulation valve of any of examples A1-A17, where the first portion comprises a sleeve extending between an upper portion of the sleeve and a lower portion of the sleeve, where the second portion comprises a telescoping housing movable relative to the first portion through an inner lumen of the sleeve to decrease the cross-sectional area of the flow path in response to an increase in pressure applied to the telescoping housing.

A19 The steam regulation valve of any of examples A1-A18, where the first portion comprises a cap, and where the telescoping housing is coupled to the cap via a spring such that the telescoping housing is movable up and down relative to the sleeve.

A20 The steam regulation valve of any of examples A1-A19, where the spring is adjustable to provide varying biasing force.

A21 The steam regulation valve of any of examples A1-A20, where the cap is coupled to the upper portion of the sleeve.

A22 The steam regulation valve of any of examples A1-A21, where the sleeve, the cap, the telescoping housing, and the spring can be disassembled for cleaning.

A23 The steam regulation valve of any of examples A1-A22, where the telescoping housing moves in a first direction relative to the sleeve to decrease the cross-sectional area of the flow path in response to an increase in pressure applied to the telescoping housing, and where the telescoping housing moves in a second direction opposite the first direction relative to the sleeve to increase the cross-sectional area of the flow path in response to a decrease in pressure applied to the telescoping housing.

A24 The steam regulation valve of any of examples A1-A23, where the telescoping housing comprises at least one opening, and where as the telescoping housing moves in a first direction relative to the sleeve, the at least one opening is at least partially blocked by the lower portion of the sleeve.

A25 The steam regulation valve of any of examples A1-A24, where the telescoping housing comprises a plurality of openings with the same or different configurations.

A26 The steam regulation valve of any of examples A1-A25, where the telescoping housing comprises at least one opening extending along a length of the telescoping housing, where the at least one opening includes a first section and a second section along the length of the telescoping housing, where when the telescoping housing moves relative to the sleeve to expose the first section of the at least one opening, the cross-sectional area of the flow path increases linearly, and where as the telescoping housing continues to move relative to the sleeve to expose the second section of the at least one opening, the cross-sectional area of the flow path increases non-linearly.

A27 The steam regulation valve of any of examples A1-A26, where the second section of the at least one opening is wider than the first section of the at least one opening.

B1 In an example, a pressure cooker comprises: a cooker body and a lid enclosing a cooking chamber; and a steam regulation valve comprising a valve body, where the steam regulation valve defines a flow path in fluid communication with the cooking chamber, the flow path selectively in fluid communication with an atmosphere surrounding the pressure cooker, and where the valve body is movable to decrease a cross-sectional area of the flow path in response to an increase in pressure in the cooking chamber, and movable to increase the cross-sectional area of the flow path in response to a decrease in pressure in the cooking chamber.

B2 The pressure cooker of example B1, where the steam regulation valve is associated with the lid.

B3 The pressure cooker of example B1 or B2, where the steam regulation valve is associated with the cooker body.

B4 The pressure cooker of any of examples B1-B3, where the valve body is movable to decrease the cross-sectional area of the flow path linearly in response to an increase in pressure in the cooking chamber, and movable to increase the cross-sectional area of the flow path linearly in response to a decrease in pressure in the cooking chamber.

B5 The pressure cooker of any of examples B1-B4, where the valve body is movable to decrease the cross-sectional area of the flow path non-linearly in response to an increase in pressure in the cooking chamber, and movable to increase the cross-sectional area of the flow path non-linearly in response to a decrease in pressure in the cooking chamber.

B6 The pressure cooker of any of examples B1-B5, where the valve body is movable relative to the cooking chamber between a first position and a second position, where the valve body is moved to the first position in response to a first pressure applied to the valve body, the flow path having a first cross-sectional area when the valve body is in the first position, where the valve body is moved to the second position in response to a second pressure applied to the valve body, the flow path having a second cross-sectional area when the valve body is in the second position, where the first pressure is higher than the second pressure, and where the first cross-sectional area of the flow path is smaller than the second cross-sectional area of the flow path.

B7 The pressure cooker of any of examples B1-B6, where a biasing force is applied to the valve body, and where as the valve body moves between the first position and the second position, the biasing force is constant.

B8 The pressure cooker of any of examples B1-B7, where a biasing force is applied to the valve body, and where as the valve body moves between the first position and the second position, the biasing force changes linearly.

B9 The pressure cooker of any of examples B1-B8, where a biasing force is applied to the valve body, and where as the valve body moves between the first position and the second position, the biasing force changes non-linearly.

B10 The pressure cooker of any of examples B1-B9, where the valve body moves toward the cooking chamber as it moves from the first position to the second position.

B11 The pressure cooker of any of examples B1-B10, where the valve body is biased towards the second position.

B12 The pressure cooker of any of examples B1-B11, where the valve body is biased by a spring, magnet, or gravity.

B13 The pressure cooker of any of examples B1-B12, where the valve body includes a plurality of openings, where when the valve body is in the first position, a first number of the plurality of openings are exposed, where when the valve body is in the second position, a second number of the plurality of openings are exposed, and where the first number is smaller than or equal to the second number.

B14 The pressure cooker of any of examples B1-B13, where the valve body includes an opening extending along a length of the valve body, where when the valve body is in the first position, a first portion of the opening is exposed, where when the valve body is in the second position, the first portion of the opening and a second portion of the opening are exposed.

B15 The pressure cooker of any of examples B1-B14, where the valve body is collapsible such that the valve body transitions between a collapsed configuration and an expanded configuration.

B16 The pressure cooker of any of examples B1-B15, where the steam regulation valve further comprises a first passage in fluid communication with the cooking chamber, and where the steam regulation valve further comprises a second passage selectively in fluid communication with the atmosphere.

B17 The pressure cooker of any of examples B1-B16, where the valve body comprises a flap disposed along the first passage, and where the flap is configured to decrease the cross-sectional area of the flow path in response to an increase in pressure applied to the flap.

B18 The pressure cooker of any of examples B1-B17, where the valve body comprises at least one arm moveable relative to the first passage to decrease the cross-sectional area of the flow path in response to an increase in pressure applied to the at least one arm.

B19 The pressure cooker of any of examples B1-B18, where the valve body comprises a ball moveable relative to the first passage to decrease the cross-sectional area of the flow path in response to an increase in pressure applied to the ball.

B20 The pressure cooker of any of examples B1-B19, where the valve body comprises a conduit moveable relative to the first passage and the second passage, and where the conduit selectively connects the first passage and the second passage to form the flow path with varying cross-sectional areas.

B21 The pressure cooker of any of examples B1-B20, where the steam regulation valve comprises a sleeve extending between an upper portion of the sleeve and a lower portion of the sleeve, where the valve body comprises a housing extending through an inner lumen of the sleeve, and where the housing is movable relative to the cooking chamber to decrease the cross-sectional area of the flow path in response to an increase in pressure in the cooking chamber.

B22 The pressure cooker of any of examples B1-B21, where the housing is movable relative to the cooking chamber to increase the cross-sectional area of the flow path in response to a decrease in pressure in the cooking chamber.

B23 The pressure cooker of any of examples B1-B22, where the housing is biased towards the cooking chamber.

B24 The pressure cooker of any of examples B1-B23, where the housing is biased by a spring, magnet, or gravity.

B25 The pressure cooker of any of examples B1-B24, where the housing moves away from the cooking chamber to decrease the cross-sectional area of the flow path in response to an increase in pressure in the cooking chamber, and where the housing moves toward the cooking chamber to increase the cross-sectional area of the flow path in response to a decrease in pressure in the cooking chamber.

B26 The pressure cooker of any of examples B1-B25, where the housing comprises at least one opening, and where as the housing moves away from the cooking chamber, at least a portion of the at least one opening is blocked by the lower portion of the sleeve.

B27 The pressure cooker of any of examples B1-B26, where the telescoping housing comprises a plurality of openings with the same or different configurations.

B28 The pressure cooker of any of examples B1-B27, where the steam regulation valve comprises a cap, and where the housing is coupled to the cap via a spring such that the housing is movable up and down relative to the sleeve, and where the cap is coupled to the upper portion of the sleeve.

B29 The pressure cooker of any of examples B1-B28, where the spring is adjustable to provide varying biasing force.

B30 The pressure cooker of any of examples B1-B29, where the sleeve, the cap, the housing, and the spring can be disassembled for cleaning.

B31 The pressure cooker of any of examples B1-B30, where the housing comprises at least one opening extending along a length of the housing, where the at least one opening includes a first section and a second section along the length of the housing, where when the housing moves toward the cooking chamber to expose the first section of the at least one opening, the cross-sectional area of the flow path increases linearly, and where as the housing continues to move toward the cooking chamber to expose the second section of the at least one opening, the cross-sectional area of the flow path increases non-linearly.

B32 The pressure cooker of any of examples B1-B31, where the second section of the at least one opening is wider than the first section of the at least one opening.

C1 In an example, a method of regulating steam release of a pressure cooker with a steam regulation valve, the pressure cooker including a cooker body enclosing a cooking chamber, the method comprises: moving a portion of the steam regulation valve to a first position to release steam in the cooking chamber via a flow path through the steam regulation valve, the flow path having a first cross-sectional area in response to a first pressure in the cooking chamber; and moving the portion of the steam regulation valve to a second position to release steam in the cooking chamber via the flow path through the steam regulation valve, the flow path having a second cross-sectional area in response to a second pressure in the cooking chamber, where the first pressure is higher than the second pressure, and where the first cross-sectional area is smaller than the second cross-sectional area.

C2 The method of example C1, where a biasing force is applied to the portion of the steam regulation valve, and where as the portion of the steam regulation valve moves between the first position and the second position, the biasing force is constant.

C3 The method of example C1 or C2, where a biasing force is applied to the portion of the steam regulation valve, and where as the portion of the steam regulation valve moves between the first position and the second position, the biasing force changes linearly.

C4 The method of any of examples C1-C3, where a biasing force is applied to the portion of the steam regulation valve, and where as the portion of the steam regulation valve moves between the first position and the second position, the biasing force changes non-linearly.

C5 The method of any of examples C1-C4, further comprises: moving the portion of the steam regulation valve from the second position to the first position in response to an increase in pressure in the cooking chamber; and moving the portion of the steam regulation valve from the first position to the second position in response to a decrease in pressure in the cooking chamber.

C6 The method of any of examples C1-05, further comprises: changing a cross-sectional area of the flow path linearly, non-linearly, or exponentially as the portion of the steam regulation valve moves between the first position and the second position.

C7 The method of any of examples C1-C6, further comprises: moving the portion of the steam regulation valve over time from the first position to the second position as the pressure in the cooking chamber changes from the first pressure to the second pressure.

C8 The method of any of examples C1-C7, moving the portion of the steam regulation valve over time from the second position to the first position as the pressure in the cooking chamber changes from the second pressure to the first pressure.

D1 In an example, a steam regulation valve comprises: a main body; and a telescoping housing movable relative to the main body, where the telescoping housing includes at least one opening through which a flow path passes, and where the telescoping housing is movable relative to the main body to decrease a cross-sectional area of the flow path in response to an increase in pressure applied to the telescoping housing.

D2 The steam regulation valve of example D1, where the telescoping housing is movable relative to the main body to decrease the cross-sectional area of the flow path linearly in response to an increase in pressure applied to the telescoping housing.

D3 The steam regulation valve of example D1 or D2, where the telescoping housing is movable relative to the main body to decrease the cross-sectional area of the flow path non-linearly in response to an increase in pressure applied to the telescoping housing.

D4 The steam regulation valve of any of examples D1-D3, where the telescoping housing is movable relative to the main body to increase the cross-sectional area of the flow path in response to a decrease in pressure applied to the telescoping housing.

D5 The steam regulation valve of any of examples D1-D4, where a biasing force is applied to the telescoping housing, and where as the telescoping housing moves to decrease the cross-sectional area of the flow path in response to an increase in pressure applied to the telescoping housing, the biasing force is constant.

D6 The steam regulation valve of any of examples D1-D5, where a biasing force is applied to the telescoping housing, and where as the telescoping housing moves to decrease the cross-sectional area of the flow path in response to an increase in pressure applied to the telescoping housing, the biasing force changes linearly.

D7 The steam regulation valve of any of examples D1-D6, where a biasing force is applied to the telescoping housing, and where as the telescoping housing moves to decrease the cross-sectional area of the flow path in response to an increase in pressure applied to the telescoping housing, the biasing force changes non-linearly.

D8 The steam regulation valve of any of examples D1-D7, where the telescoping housing moves in a first direction relative to the main body to decrease the cross-sectional area of the flow path in response to an increase in pressure applied to the telescoping housing, and where the telescoping housing moves in a second direction opposite the first direction relative to the main body to increase the cross-sectional area of the flow path in response to a decrease in pressure applied to the telescoping housing.

D9 The steam regulation valve of any of examples D1-D8, where the telescoping housing is biased in the second direction relative to the main body.

D10 The steam regulation valve of any of examples D1-D9, where the telescoping housing is biased by a spring, magnet, or gravity.

D11 The steam regulation valve of any of examples D1-D10, where as the telescoping housing moves in a first direction relative to the main body, at least a portion of the at least one opening is blocked by the main body.

E1 In an example, a steam regulation valve comprises: a main body; and a collapsible valve body movable relative to the main body between a first configuration and a second configuration, where the collapsible valve body includes at least one opening through which a flow path passes, where the collapsible valve body is moved to the first configuration in response to a first pressure applied to the collapsible valve body, where the flow path has a first cross-sectional area when the collapsible valve body is in the first configuration, where the collapsible valve body is moved to the second configuration in response to a second pressure applied to the collapsible valve body, where the flow path has a second cross-sectional area when the collapsible valve body is in the second configuration, where the first pressure is higher than the second pressure, and where the first cross-sectional area is smaller than the second cross-sectional area.

E2 The steam regulation valve of example E1, where the first configuration is a collapsed configuration and the second configuration is an expanded configuration.

E3 The steam regulation valve of example E1 or E2, where a biasing force is applied to the collapsible valve body, and where as the collapsible valve body moves between the first configuration and the second configuration, the biasing force is constant.

E4 The steam regulation valve of any of examples E1-E3, where a biasing force is applied to the collapsible valve body, and where as the collapsible valve body moves between the first configuration and the second configuration, the biasing force changes linearly.

E5 The steam regulation valve of any of examples E1-E4, where a biasing force is applied to the collapsible valve body, and where as the collapsible valve body moves between the first configuration and the second configuration, the biasing force changes non-linearly.

E6 The steam regulation valve of any of examples E1-E5, where the collapsible valve body includes a plurality of openings through which the flow path passes, where a first number of the plurality of openings are blocked by the collapsed valve body in the first configuration, where a second number of the plurality of openings are blocked by the collapsed valve body in the second configuration, and where the first number is greater than the second number.

E7 The steam regulation valve of any of examples E1-E6, where the collapsible valve body includes a plurality of openings through which the flow path passes, where when the collapsible valve body is in the first configuration, a first number of the plurality of openings are exposed, where when the collapsible valve body is in the second configuration, a second number of the plurality of openings are exposed, and where the first number is smaller than or equal to the second number.

E8 The steam regulation valve of any of examples E1-E7, where the collapsible valve body is movable relative to the main body towards the first configuration to decrease a cross-sectional area of the flow path in response to an increase in pressure applied to the collapsible valve body.

E9 The steam regulation valve of any of examples E1-E8, where the collapsible valve body is movable relative to the main body towards the first configuration to decrease the cross-sectional area of the flow path linearly in response to an increase in pressure applied to the collapsible valve body.

E10 The steam regulation valve of any of examples E1-E9, where the collapsible valve body is movable relative to the main body towards the first configuration to decrease the cross-sectional area of the flow path non-linearly in response to an increase in pressure applied to the collapsible valve body.

E11 The steam regulation valve of any of examples E1-E10, where the collapsible valve body is movable relative to the main body towards the second configuration to increase a cross-sectional area of the flow path in response to a decrease in pressure applied to the collapsible valve body.

F1 In an example, a steam regulation valve comprises: a main body including a passage configured to provide a flow path through the valve; and a flap disposed adjacent to the passage, where the flap is movable to decrease a cross-sectional area of the flow path in response to an increase in pressure applied to the flap.

F2 The steam regulation valve of example F1, where the flap is movable to decrease the cross-sectional area of the flow path linearly in response to an increase in pressure applied to the flap.

F3 The steam regulation valve of example F1 or F2, where the flap is movable to decrease the cross-sectional area of the flow path non-linearly in response to an increase in pressure applied to the flap.

F4 The steam regulation valve of any of examples F1-F3, where the flap is movable to increase the cross-sectional area of the flow path in response to a decrease in pressure applied to the flap.

F5 The steam regulation valve of any of examples F1-F4, where a biasing force is applied to the flap, and where as the flap moves to decrease the cross-sectional area of the flow path in response to an increase in pressure applied to the flap, the biasing force is constant.

F6 The steam regulation valve of any of examples F1-F5, where a biasing force is applied to the flap, and where as the flap moves to decrease the cross-sectional area of the flow path in response to an increase in pressure applied to the flap, the biasing force changes linearly.

F7 The steam regulation valve of any of examples F1-F6, where a biasing force is applied to the flap, and where as the flap moves to decrease the cross-sectional area of the flow path in response to an increase in pressure applied to the flap, the biasing force changes non-linearly.

F8 The steam regulation valve of any of examples F1-F7, where the flap is made of rubber.

F9 The steam regulation valve of any of examples F1-F8, where the flap has an annular configuration.

F10 The steam regulation valve of any of examples F1-F9, where the flap includes a planar portion forming an aperture, where the planar portion is configured to decrease a cross-sectional area of the aperture in response to an increase in pressure applied to the flap, and where the planar portion is configured to increase the cross-sectional area of the aperture in response to a decrease in pressure applied to the flap.

F11 The steam regulation valve of any of examples F1-F10, where the planar portion is movable between a first position and a second position, where the planar portion is moved to the first position in response to a first pressure applied to the planar portion, the flow path having a first cross-sectional area when the planar portion is in the first position, where the planar portion is moved to the second position in response to a second pressure applied to the planar portion, the flow path having a second cross-sectional area when the planar portion is in the second position, where the first pressure is higher than the second pressure, and where the first cross-sectional area of the flow path is smaller than the second cross-sectional area of the flow path.

F12 The steam regulation valve of any of examples F1-F11, where an elastic force biases the planar portion towards the second position when the planar portion is in the first position.

G1 In an example, a steam regulation valve comprises a main body including a passage configured to provide a flow path through the valve; and at least one arm moveable relative to the passage to decrease a cross-sectional area of the flow path in response to an increase in pressure applied to the at least one arm.

G2 The steam regulation valve of example G1, where the at least one arm is moveable relative to the passage to decrease the cross-sectional area of the flow path linearly in response to an increase in pressure applied to the at least one arm.

G3 The steam regulation valve of example G1 or G2, where the at least one arm is moveable relative to the passage to decrease the cross-sectional area of the flow path non-linearly in response to an increase in pressure applied to the at least one arm.

G4 The steam regulation valve of any of examples G1-G3, where the at least one arm is moveable relative to the passage to increase the cross-sectional area of the flow path in response to a decrease in pressure applied to the at least one arm.

G5 The steam regulation valve of any of examples G1-G4, where a biasing force is applied to the at least one arm, and where as the at least one arm moves to decrease the cross-sectional area of the flow path in response to an increase in pressure applied to the at least one arm, the biasing force is constant.

G6 The steam regulation valve of any of examples G1-G5, where a biasing force is applied to the at least one arm, and where as the at least one arm moves to decrease the cross-sectional area of the flow path in response to an increase in pressure applied to the at least one arm, the biasing force changes linearly.

G7 The steam regulation valve of any of examples G1-G6, where a biasing force is applied to the at least one arm, and where as the at least one arm moves to decrease the cross-sectional area of the flow path in response to an increase in pressure applied to the at least one arm, the biasing force changes non-linearly.

G8 The steam regulation valve of any of examples G1-G7, where the at least one arm comprises two arms, where the two arms move towards each other in response to an increase in pressure applied to the two arms, and where the two arms move away from each other in response to a decrease in pressure applied to the two arms.

G9 The steam regulation valve of any of examples G1-G8, the at least one arm is pivotably coupled to the main body to selectively block at least a portion of the passage.

H1 In an example, a steam regulation valve comprises a main body including a narrowing portion, the narrowing portion having a passage through which a flow path passes; and a valve body moveable relative to the passage to decrease a cross-sectional area of the flow path in response to an increase in pressure applied to the valve body.

H2 The steam regulation valve of example H1, where the valve body is moveable relative to the passage to decrease the cross-sectional area of the flow path linearly in response to an increase in pressure applied to the valve body.

H3 The steam regulation valve of example H1 or H2, where the valve body is moveable relative to the passage to decrease the cross-sectional area of the flow path non-linearly in response to an increase in pressure applied to the valve body.

H4 The steam regulation valve of any of examples H1-H3, where the valve body is moveable relative to the passage to increase the cross-sectional area of the flow path in response to a decrease in pressure applied to the valve body.

H5 The steam regulation valve of any of examples H1-H4, where a biasing force is applied to the valve body, and where as the valve body moves to decrease the cross-sectional area of the flow path in response to an increase in pressure applied to the valve body, the biasing force is constant.

H6 The steam regulation valve of any of examples H1-H5, where a biasing force is applied to the valve body, and where as the valve body moves to decrease the cross-sectional area of the flow path in response to an increase in pressure applied to the valve body, the biasing force changes linearly.

H7 The steam regulation valve of any of examples H1-H6, where a biasing force is applied to the valve body, and where as the valve body moves to decrease the cross-sectional area of the flow path in response to an increase in pressure applied to the valve body, the biasing force changes non-linearly.

H8 The steam regulation valve of any of examples H1-H7, where the valve body is moved towards the passage to decrease the cross-sectional area of the flow path in response to an increase in pressure applied to the valve body, and where the valve body is moved away from the passage to increase the cross-sectional area of the flow path in response to a decrease in pressure applied to the valve body.

H9 The steam regulation valve of any of examples H1-H8, where the valve body is moved in a first direction in the narrowing portion in response to an increase in pressure applied to the valve body, and where the valve body is moved in a second direction opposite the first direction in the narrowing portion in response to a decrease in pressure applied to the valve body.

H10 The steam regulation valve of any of examples H1-H9, where the valve body is a ball.

I1 In an example, a steam regulation valve comprises: a main body including a first passage and a second passage, forming a flow path between the first passage and the second passage; and a valve body including a conduit, wherein the valve body is moveable relative to the first and second passages to decrease a cross-sectional area of the flow path in response to an increase in pressure applied to the valve body.

I2 The steam regulation valve of example I1, where the valve body is moveable relative to the first and second passages to decrease the cross-sectional area of the flow path linearly in response to an increase in pressure applied to the valve body.

I3 The steam regulation valve of example I1 or I2, where the valve body is moveable relative to the first and second passages to decrease the cross-sectional area of the flow path non-linearly in response to an increase in pressure applied to the valve body.

I4 The steam regulation valve of any of examples I1-I3, where the valve body is moveable relative to the first and second passages to increase the cross-sectional area of the flow path in response to a decrease in pressure applied to the valve body.

I5 The steam regulation valve of any of examples I1-I4, where a biasing force is applied to the valve body, and where as the valve body moves to decrease the cross-sectional area of the flow path in response to an increase in pressure applied to the valve body, the biasing force is constant.

I6 The steam regulation valve of any of examples I1-I5, where a biasing force is applied to the valve body, and where as the valve body moves to decrease the cross-sectional area of the flow path in response to an increase in pressure applied to the valve body, the biasing force changes linearly.

I7 The steam regulation valve of any of examples I1-I6, where a biasing force is applied to the valve body, and where as the valve body moves to decrease the cross-sectional area of the flow path in response to an increase in pressure applied to the valve body, the biasing force changes non-linearly.

I8 The steam regulation valve of any of examples I1-I7, where the conduit of the valve body is selectively in fluid communication with the first and second passages.

I9 The steam regulation valve of any of examples I1-I8, where the valve body is biased towards the flow path between the first passage and the second passage.

I10 The steam regulation valve of any of examples I1-I9, where the valve body is biased by a spring, magnet, or gravity.

I11 The steam regulation valve of any of examples I1-I10, where the valve body is moved in a first direction relative to the main body in response to an increase in pressure applied to the valve body, and where the valve body is moved in a second direction opposite the first direction relative to the main body in response to a decrease in pressure applied to the valve body.

I12 The steam regulation valve of any of examples I1-I11, where the valve body is moved in a first direction relative to the first and second passages to decrease a cross-sectional area of the conduit that is in fluid communication with the first and second passages in response to an increase in pressure applied to the valve body.

I13 The steam regulation valve of any of examples I1-I12, where the valve body is moved in a second direction opposite the first direction relative to the first and second passages to increase a cross-sectional area of the conduit that is in fluid communication with the first and second passages in response to a decrease in pressure applied to the valve body.

J1 In an example, a steam regulation valve comprises a sleeve extending between an upper portion of the sleeve and a lower portion of the sleeve, the sleeve having an inner lumen extending between the upper portion of the sleeve and the lower portion of the sleeve; and a telescoping housing extending through the inner lumen and including at least one opening through which a flow path passes, where the telescoping housing is movable relative to the sleeve to decrease a cross-sectional area of the flow path in response to an increase in pressure applied to the telescoping housing.

J2 The steam regulation valve of example J1, where the telescoping housing is movable relative to the sleeve to decrease the cross-sectional area of the flow path linearly in response to an increase in pressure applied to the telescoping housing.

J3 The steam regulation valve of example J1 or J2, where the telescoping housing is movable relative to the sleeve to decrease the cross-sectional area of the flow path non-linearly in response to an increase in pressure applied to the telescoping housing.

J4 The steam regulation valve of any of examples J1-J3, where the telescoping housing is movable relative to the sleeve to increase the cross-sectional area of the flow path in response to a decrease in pressure applied to the telescoping housing.

J5 The steam regulation valve of any of examples J1-J4, where a biasing force is applied to the telescoping housing, and where as the telescoping housing moves to decrease the cross-sectional area of the flow path in response to an increase in pressure applied to the telescoping housing, the biasing force is constant.

J6 The steam regulation valve of any of examples J1-J5, where a biasing force is applied to the telescoping housing, and where as the telescoping housing moves to decrease the cross-sectional area of the flow path in response to an increase in pressure applied to the telescoping housing, the biasing force changes linearly.

J7 The steam regulation valve of any of examples J1-J6, where a biasing force is applied to the telescoping housing, and where as the telescoping housing moves to decrease the cross-sectional area of the flow path in response to an increase in pressure applied to the telescoping housing, the biasing force changes non-linearly.

J8 The steam regulation valve of any of examples J1-J7, further comprises a cap, where the telescoping housing is coupled to the cap via a spring such that the telescoping housing is movable up and down relative to the sleeve.

J9 The steam regulation valve of any of examples J1-J8, where the cap comprises at least one opening.

J10 The steam regulation valve of any of examples J1-J9, where the spring is adjustable to provide varying biasing force.

J11 The steam regulation valve of any of examples J1-J10, where the cap is coupled to the upper portion of the sleeve.

J12 The steam regulation valve of any of examples J1-J11, where the sleeve, the cap, the telescoping housing, and the spring can be disassembled for cleaning.

J13 The steam regulation valve of any of examples J1-J12, where the telescoping housing moves in a first direction along the inner lumen of the sleeve to decrease the cross-sectional area of the flow path in response to an increase in pressure applied to the telescoping housing, and where the telescoping housing moves in a second direction opposite the first direction along the inner lumen of the sleeve to increase the cross-sectional area of the flow path in response to a decrease in pressure applied to the telescoping housing.

J14 The steam regulation valve of any of examples J1-J13, where the telescoping housing comprises at least one opening, and where as the telescoping housing moves in a first direction along the inner lumen of the sleeve, the at least one opening is at least partially blocked by the lower portion of the sleeve.

J15 The steam regulation valve of any of examples J1-J14, where the at least one opening extends along a length of the telescoping housing, where the at least one opening includes a first section and a second section along the length of the telescoping housing, where when the telescoping housing moves in a second direction opposite the first direction to expose the first section of the at least one opening, the cross-sectional area of the flow path increases linearly, and where as the telescoping housing continues to move in the second direction to expose the second section of the at least one opening, the cross-sectional area of the flow path increases non-linearly.

J16 The steam regulation valve of any of examples J1-J15, where the second section of the at least one opening is wider than the first section of the at least one opening.

J17 The steam regulation valve of any of examples J1-J16, where the telescoping housing comprises a plurality of openings with the same or different configurations.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1.-27. (canceled)

28. A pressure cooker, comprising:
a cooker body and a lid enclosing a cooking chamber; and
a steam regulation valve comprising a valve body,
wherein the cooker body includes cooker teeth, the lid includes lid teeth, and the cooker teeth and the lid teeth are configured to mutually latch to ensure the lid is locked onto the cooker body during cooking,
wherein the steam regulation valve defines a flow path in fluid communication with the cooking chamber, the flow path selectively in fluid communication with an atmosphere surrounding the pressure cooker, and
wherein the valve body is movable to decrease a cross-sectional area of the flow path in response to an increase in pressure in the cooking chamber, and movable to increase the cross-sectional area of the flow path in response to a decrease in pressure in the cooking chamber.

29. The pressure cooker of claim 28, wherein the steam regulation valve is associated with the lid.

30. The pressure cooker of claim 28, wherein the steam regulation valve is associated with the cooker body.

31. The pressure cooker of claim 28, wherein the valve body is movable to decrease the cross-sectional area of the flow path linearly in response to an increase in pressure in the cooking chamber, and movable to increase the cross-sectional area of the flow path linearly in response to a decrease in pressure in the cooking chamber.

32. The pressure cooker of claim 28, wherein the valve body is movable to decrease the cross-sectional area of the flow path non-linearly in response to an increase in pressure in the cooking chamber, and movable to increase the cross-sectional area of the flow path non-linearly in response to a decrease in pressure in the cooking chamber.

33. The pressure cooker of claim 28, wherein the valve body is movable relative to the cooking chamber between a first position and a second position,
wherein the valve body is moved to the first position in response to a first pressure applied to the valve body, the flow path having a first cross-sectional area when the valve body is in the first position,
wherein the valve body is moved to the second position in response to a second pressure applied to the valve body, the flow path having a second cross-sectional area when the valve body is in the second position,
wherein the first pressure is higher than the second pressure, and
wherein the first cross-sectional area of the flow path is smaller than the second cross-sectional area of the flow path.

34.-37. (canceled)

38. The pressure cooker of claim 33, wherein the valve body is biased towards the second position when the valve body is in the first position.

39.-59. (canceled)

60. A method of regulating steam release of a pressure cooker with a steam regulation valve, the pressure cooker including a cooker body enclosing a cooking chamber, the method comprising:
attaching a lid of the pressure cooker to the cooker body for pressurized cooking;
moving a portion of the steam regulation valve to a first position to release steam in the cooking chamber via a flow path through the steam regulation valve, the flow path having a first cross-sectional area in response to a first pressure in the cooking chamber; and
moving the portion of the steam regulation valve to a second position to release steam in the cooking chamber via the flow path through the steam regulation valve, the flow path having a second cross-sectional area in response to a second pressure in the cooking chamber,
wherein the first pressure is higher than the second pressure, and
wherein the first cross-sectional area is smaller than the second cross-sectional area.

61. The method of claim 60, wherein a biasing force is applied to the portion of the steam regulation valve, and wherein the portion of the steam regulation valve is biased towards the second position when the portion of the steam regulation valve is in the first position.

62.-133. (canceled)

134. A pressure cooker, comprising:
a cooker body and a lid enclosing a cooking chamber; and
a steam regulation valve,
wherein the cooker body includes cooker teeth, the lid includes lid teeth, and the cooker teeth and the lid teeth are configured to mutually latch to ensure the lid is locked onto the cooker body during cooking, and
wherein the steam regulation valve comprises:
a sleeve extending between an upper portion of the sleeve and a lower portion of the sleeve, the sleeve having an inner lumen extending between the upper portion of the sleeve and the lower portion of the sleeve; and
a telescoping housing extending through the inner lumen and including at least one opening through which a flow path passes,
wherein the telescoping housing is movable relative to the sleeve to decrease a cross-sectional area of the flow path in response to an increase in pressure applied to the telescoping housing.

135. The pressure cooker of claim 134, wherein the telescoping housing is movable relative to the sleeve to decrease the cross-sectional area of the flow path linearly in response to an increase in pressure applied to the telescoping housing.

136. The pressure cooker of claim 134, wherein the telescoping housing is movable relative to the sleeve to decrease the cross-sectional area of the flow path non-linearly in response to an increase in pressure applied to the telescoping housing.

137. The pressure cooker of claim 134, wherein the telescoping housing is movable relative to the sleeve to increase the cross-sectional area of the flow path in response to a decrease in pressure applied to the telescoping housing.

138. The pressure cooker of claim 134, wherein as the telescoping housing moves to decrease the cross-sectional area of the flow path in response to an increase in pressure applied to the telescoping housing, a constant biasing force resists the movement of the telescoping housing.

139. The pressure cooker of claim 134, wherein as the telescoping housing moves to decrease the cross-sectional area of the flow path in response to an increase in pressure applied to the telescoping housing, a biasing force resists the movement of the telescoping housing, and changes linearly.

140. The pressure cooker of claim 134, as the telescoping housing moves to decrease the cross-sectional area of the flow path in response to an increase in pressure applied to the telescoping housing, a biasing force resists the movement of the telescoping housing, and changes non-linearly.

141. The pressure cooker of claim 134, further comprising a cap, wherein the telescoping housing is coupled to the cap via a spring such that the telescoping housing is movable up and down relative to the sleeve.

142. (canceled)

143. The pressure cooker of claim 141, wherein the spring is adjustable to provide varying biasing force.

144.-145. (canceled)

146. The pressure cooker of claim 134, wherein the telescoping housing moves in a first direction along the inner lumen of the sleeve to decrease the cross-sectional area of the flow path in response to an increase in pressure applied to the telescoping housing, and wherein the telescoping housing moves in a second direction opposite the first direction along the inner lumen of the sleeve to increase the cross-sectional area of the flow path in response to a decrease in pressure applied to the telescoping housing.

147. The pressure cooker of claim 134, wherein the telescoping housing comprises at least one opening, and wherein as the telescoping housing moves in a first direction along the inner lumen of the sleeve, the at least one opening is at least partially blocked by the lower portion of the sleeve.

148.-150. (canceled)
